(19) United States
(12) Patent Application Publication
(10) Pub. No.: US 2019/0272564 A1
(43) Pub. Date: Sep. 5, 2019

(54) SUBSIDIZED RIDE HAILING

(71) Applicant: Arda Aktolun, Sunnyside, NY (US)

(72) Inventor: Arda Aktolun, Sunnyside, NY (US)

(21) Appl. No.: 15/909,999

(22) Filed: Mar. 1, 2018

(51) Int. Cl. G06Q 30/02; G06Q 10/02; G06Q 30/06

(52) U.S. Cl. CPC G06Q 30/0265; G06Q 30/0271; G06Q 30/06; G06Q 10/02; G06Q 30/0273

(57) ABSTRACT

The consumers utilize the application to summon a transportation vendor at designated locations. The vendor then transports consumers to various destinations. While the consumer pays for transportation, the application permits the consumer to earn a subsidy from a provider of marketing content broadcasted by a vendor's device, which subsidy is then applied to the immediate transportation request or held as credit for future transportation needs. The credit is earned by consumer listening to one or more live or prerecorded sponsored messages, that are generally marketing messages. The application is also used to incentivize drivers to participate in the network of vendors sustained by the software application. It does so by partially subsidizing commissions owned by vendors, provided that vendors abide by the rules of the software application. The primary rule of the software application is to ensure that the vendor does not interfere with the translation of a message made by a sponsor to a passenger and that the vendor complies with a preset minimum broadcasting level.

### FIELD OF THE INVENTION

The present invention relates to a business method and system for subsidizing for-hire transportation using third party participation.

### BACKGROUND OF THE INVENTION

The present invention aims to make commercial transportation of passengers less expensive for both passengers and operators. The current state of the art offers riders various options of booking transportation using interne resources that are broadcasted over private computing devices and smart phones. These solutions have made it much easier to get to places without using a phonebook, map or a telephone to arrange a transportation choice.

While existing solutions have made the process of pedestrian transportation easier and more streamlined, the underlining basics of the arrangements remain the same. In all instances both the vendor and rider need to register with the reservation system. The rider pays for transportation through the reservation system. The vendor returns a portion of the transportation fee charged to the rider to the reservation system as a fee for rider referral. The prior art transportation arrangement has introduced a middle-man which, in most cases, is funded by the vendor, and indirectly by the rider, through increased tariffs charged by vendors.

The present invention introduces commercial marketing as third income stream, designed to reduce costs for both vendors and riders. While prior art is replete with internet-based solutions deriving income from advertising, this income was never shared as transportation subsidy to consumers. Another downside in existing advertising solutions is that, while advertisers are able to target a specific population segment, they have little control on whether the consumers will absorb or even listen to their marketing offerings. Therefore, the prior art focuses on the effort to present a promotional message before a target consumer, which is usually accomplished through mass broadcasting to population segment that satisfies a certain range of parameters. Very little attention is paid on controlling or determining whether the message is actually received or absorbed by the consumer.

Therefore, it is an object of the present invention to introduce a third party that is able to subsidize public transportation, and which directly or indirectly reduces participation costs for vendors.

It is another object of the present invention to ensure that not only are relevant advertising messages are presented to consumers, the advertisers are able to verify and enforce message consumption by targeted consumer.

It is another object of the present invention to ensure that vendors are rated based on quality of services and based on compliance level with the rules of the application.

It is another object of the present invention to create a ride sharing application that can detect and discourage behaviors by riders or vendors that tend to circumvent the rule of the ride sharing application.

### SUMMARY OF THE INVENTION

The present invention is a computer application that enables a method for arranging transportation for consumers. The consumers utilize the application to summon a transportation vendor at designated locations. The vendor then transports consumers to various destinations. While the consumer pays for transportation, the application permits the consumer to earn a subsidy from a provider of marketing content broadcasted by a vendor's device, which subsidy is then applied to the immediate transportation request or held as credit for future transportation needs. The credit is earned by consumer listening to one or more live or prerecorded sponsored messages, that are generally marketing messages.

The application is also used to incentivize drivers to participate in the network of vendors sustained by the software application. It does so by partially subsidizing commissions owned by vendors, provided that vendors abide by the rules of the software application. The primary rule of the software application is to ensure that the vendor does not interfere with the translation of a message made by a sponsor to a passenger and that the vendor complies with a preset minimum broadcasting level.

The software application contains sensors that are able to detect whether the vendor (and/or consumer) has complied with the minimum broadcasting compliance level. Insufficient level of compliance results in the passenger/consumer not receiving a subsidy or credit for the transportation or receiving a reduced subsidy. A penalty to the vendor may be as mild as a reduced subsidy of a commission or more severe, as in the instances of suspension and exclusion from participating as a vendor in the software application.

The software application polices not only message broadcasting by Vendors, but also attentiveness and participation by consumers. It does so by presenting random quizzes to Consumers to determine relevancy of sponsored messages, as well as attentiveness by consumer to messages being broadcasted. Such quizzes may be provided as a prerequisite to a consumer's scheduling of the next ride, or as a condition of receiving a credit or subsidy for a past ride. The software application uses the same quizzes to gauge consumer interests, religious/political/social affiliation, age, and income levels, prior browsing history, starting points and destinations, and many other attributes to customize sponsored messages to a more congruent set depending on a consumer.

Finally, the software application maintains a competitive level of vendor participation by having an auction determine how many times a sponsored message may be played, and in what order it will be presented to consumers. For example, it may be the case that the first and last messages, if several are played, are the most desirable sponsor positions. The first message may be more effective than other positions because the consumer entering a transportation module is more likely to remember the first message broadcasted. The last message played may be even more valuable, since consumers are more attentive just before leaving the mode of transportation, as they do not wish to forget their packages or to not wish to miss, their disembarkation points. Therefore, messages broadcasted at that time will likely receive the greatest focus and clarity of mind than messages broadcasted during the course of transport.

### BRIEF DESCRIPTION OF THE DRAWINGS

FIGS. 1-3, 3A are step diagrams demonstrating the general steps of the method of the present invention.

FIGS. 4 & 5 are sequential diagrams, illustrating the software application process of the present invention.

FIGS. 6 & 7 are screenshots of the smartphone device equipped with the software application.

FIGS. 8A & 8B are layout diagrams of the physical aspects of the software application.

FIGS. 9 & 10 are examples of usage of the present invention.

### DESCRIPTION OF THE PREFERRED EMBODIMENTS

The preferred embodiments of the present invention will now be described with reference to the drawings. Identical elements in the various figures are identified with the, same reference numerals.

Reference will now be made in detail to embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

Turning now descriptively to the drawings, in which similar reference characters denote similar elements throughout the several views.

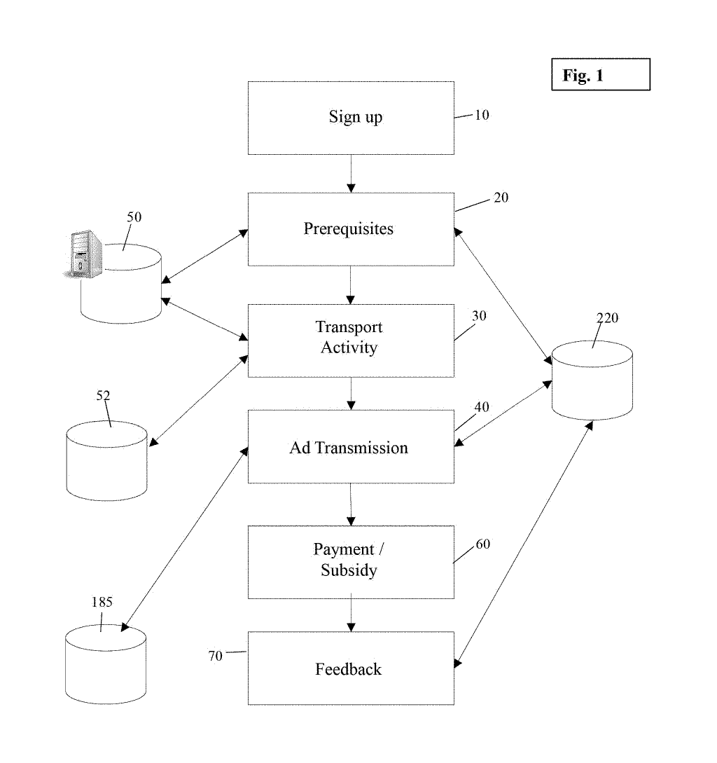

FIG. 1 shows a diagram of a consumer sign up process, which begins with a sign-up 10 and a profile step 20. The software application 2 (FIGS. 8A/B) collects pertinent information, such as rider's identity, contact information, address, purpose for travel, travel schedule, and payment method.

User input by the rider/consumer is recorded on the consumer's device locally and transmitted to a central user database as soon as a network connection with the software application server has been established. User parameters, once entered, is saved within the users database 50. The users database 50 may be in the form of a file or as a commercially available database software. All databases disclosed in this application may be disposed over one or more servers, and linked via disc linkage or as a software cluster enforced by the software application or by the commercial database package and coordinated by the software application.

Once user's profile entries have been successfully recorded, whether locally, on server or both, the rider is ready to login into the application to arrange transportation in step 30. The mode of transportation may vary depending on the implementational context of the software. While private automotive for-hire transportation yields most readily to the transportation arrangement system disclosed in the present invention, other types of transportation modes may be equally adaptable to this form of ride booking. For the example, the system disclosed in the present invention may be used to arrange air transport for leisure, professional or emergency purposes, to summon a helicopter or a private plane service.

The transmission of messages from sponsors at step 40 occurs at a point between the initial reservation of the trip by the consumer in step 30 and the conclusion of the trip. Preferably, promotional data is loaded at the outset of the transportation request to be ready for broadcasting as soon as the consumer enters the transport medium that will be ferrying the consumer to his or her destination. Messages from sponsors will be in the form of audio advertisements received from advertisements database 50 or from adprefs database 220, or directly from 3^{rd} party databases controlled by sponsors, in coordination with advertisements or adprefs database, 185 or 220.

At the start or end of a trip, the consumer/rider pays for the ride and depending on whether a marketing message was broadcasted to the consumer in an acceptable or compliant manner, the consumer will also be awarded as form of subsidy or co-pay, which will be applied to rider's existing transportation charge or saved on rides database 52 as a credit for future transport activity. To improve efficiency and minimize costs to the vendors, all applicable credits will be applied to vendor's charge before a payment is due by the consumer. This will minimize transactional costs and make the usage of the application more predictable.

During the ride or at the conclusion of it, the rider will be actively solicited for a feedback in step 70. Feedback 70 may be initiated by the rider before, during and after a scheduled ride. During feedback 70, the user will be asked to grade the quality of the ride, professionalism of the ride vendor, suitability or class of equipment used by the vendor as well as level of compliance by vendor with the software method disclosed in this invention. For example, if the vendor deliberately or inadvertently inhibited the reception or broadcast of marketing messages to the rider, the rider may then have the opportunity to complain to the software application vendor in an effort to recoup some or all of the possible subsidy.

The vendor/driver facilitates in the implementation of the present invention by signing up in step 90. The sign-up process verifies whether the vendor is qualified to provide regular civilian transportation service, and that the vendor will utilize suitable equipment. Part of the equipment check will be to confirm whether the Vendor's audio/video receiving device is capable of receiving and broadcasting messages from the adpref's 220 database to the consumers.

The vendor data is recorded in the users database 50 or in a separate database. The driver sign-up may be effectuated using the driver's /vendor's remote device or a computer. Information about the vendor including the storage of carrier services certificates, relevant insurance/indemnity information and payment account information, make up the bulk of drives pre-requisite registration information after step 100. This information will be stored in a centralized location but may also be initially recorded on a vendors' device, at least until a connection With a centralized location can be established.

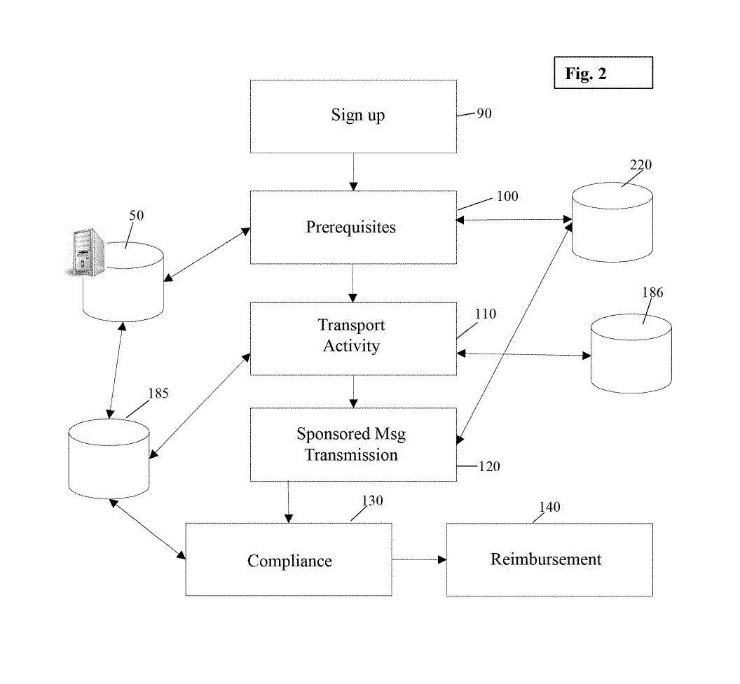

Once within the method embodied in the present invention, the vendor may begin providing transportation services in step 110. The present invention contains internal logic (FIG. 7) that calibrates source and destination locations using the polygonarray database 186, as well as service times, to calibrate the appropriate fee and charges, as well as to provide pickup and destination instructions to the vendor or vendor's agents. Prior to rider's entry into vendor's transport unit, which may be an automobile, a van, a bus, a train or an air transport medium, or an autonomous vehicle, such as a drone, the vendor's system will receive a set of promotional messages to be replayed to the vendor in step 120 (FIG. 2).

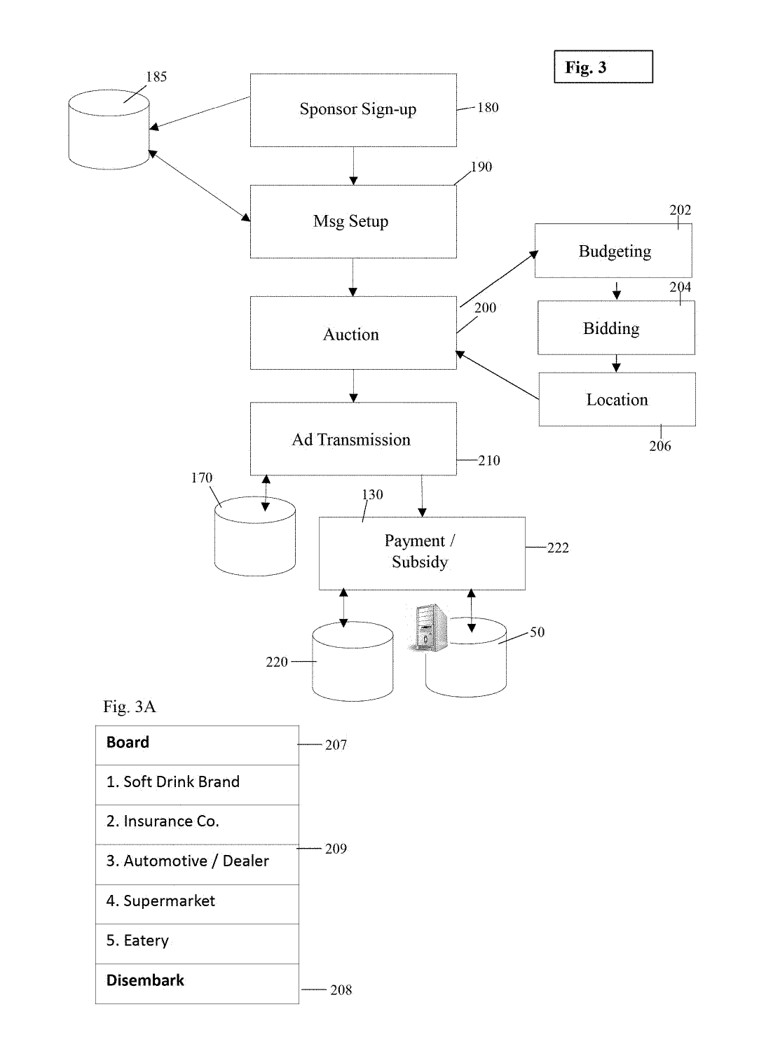

In step 120, the software application will direct a message or messages from a sponsor or sponsors to the vendor. The messages will be in the form of advertisements or announcements. The sponsors are commercial entities, who have registered (FIG. 3) with the software vendor embodied in this invention, as providers of certain goods or services. The advertisers being sent to the vendor while the vendor is ferrying this specific rider have been selected by the software application based on rider's specified preferences, needs and interests, prior consumer activity, a characteristic of consumer's profile or to the locale of the pickup or destination. The messages may be broadcasted to the riding consumer via the audio system present in vendor's transport vehicle. This message may also be presented to the consumer on vendor's video or three-dimensional displaying device.

The software application will then detect the replay and its quality in step 130. The software application gives sponsors a guarantee that their message will be heard, or the sponsor will be exempted from paying all or some of the advertising charge. The detection processes may involve a confirmation that promotional audio or video, recording has been received by/the Vendor, a replay sensor, that, determines whether the audio/visual file had been opened by the vendor or a sound detector that may detect the decibel level of the replay and determine whether it has been sufficient for the particular message in question. The compliance information is fed into the user database 50, or the advertisement database 185 and used to calculate a charge to the sponsor, and a reimbursement or subsidy, if any, to the rider and/or vendor in step 140. The compliance step 130 may also give the vendor the opportunity to rate consumer's compliance with the software application. For example, the vendor may call out a rider who does not wish to hear the promotional messages, and in so doing, is unnecessarily penalizing the vendor. The ability to provide feedback 70 by a consumer in FIG. 1 and by the vendor in step 130 provides a measure of self-enforcing compliance with the software application rules, that should further reassure sponsors of the effectiveness of the present invention as a means of effective targeted marketing.

FIG. 3 provides the series of steps taken by a third-party entity in becoming a participating sponsor of the riding and vending activity embodied in the present invention. In step 180 the third-party logs into the portal supplied by the software package (for example FIG. 8) and establishes credentials, such as account setup, goods/services registration, payment methods and budgets., marketing targets and goals. This information is then recorded in step 190 in the advertisement database 185.

Next the third-party sponsor 180 then participates in an auction 200. The auction determines the cost, position and duration for the marketing messages. For example, the sponsor may set a budget in step 202, bid on position and duration of a message in step 204, within a target location 206. For example, in FIG. 3A, the soft drink company occupies the first position in the queue 209. This position is closest to boarding 204 and is therefore broadcasted ahead of positions 2-5. The last broadcast for a restaurant in position 5 is played right before the rider disembarks 208. If the ride is delayed or lengthened for any reason, the number of promotional messages in the queue 209 may increase. Similarly, if disembarkation 208 occurs earlier, fewer promotional messages will be broadcasted.

In the presentation step 222, the advertising messages are fed to the Vendor's audio/video system for broadcasting (FIG. 2, step 120). The broadcasting of the message determines the charge to the sponsor. Part of the charge to the sponsor includes any subsidy to the rider/vendor. Information for rider/vendor viewing activity may be received from the user database 50, the adpref database 220 or any other database. A storage facility 170 may exist for tracking performance and goals of a specific advertisement message or a marketing campaign. Alternatively, this information may be recorded in a table of an existing database.

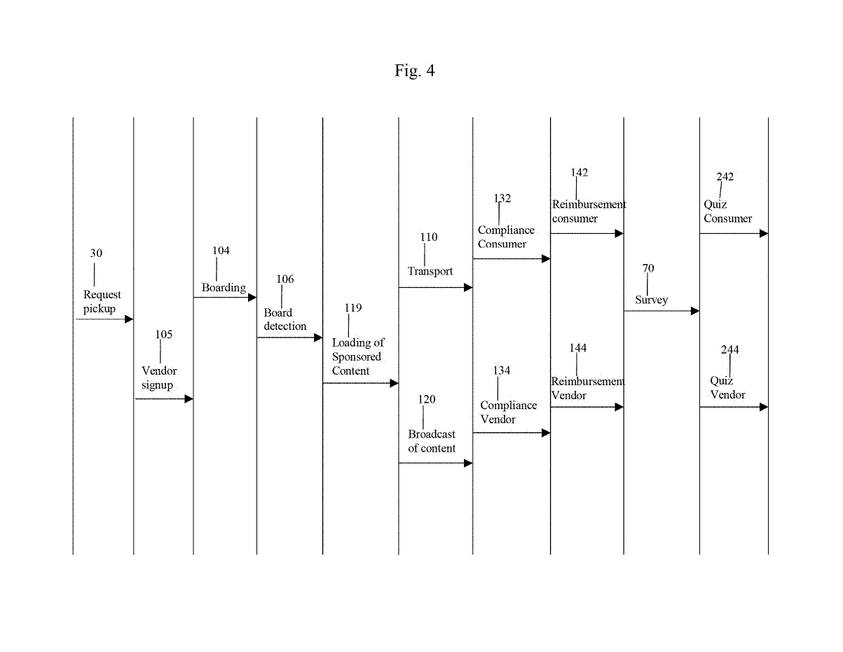

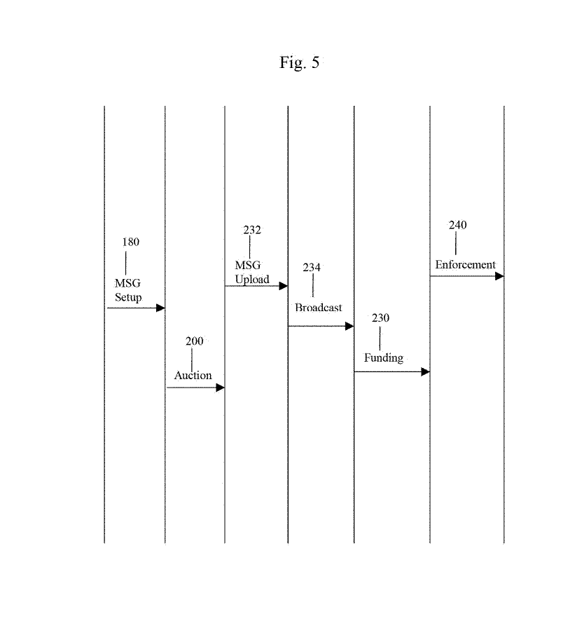

FIGS. 4 and 5 demonstrate the flow diagram of the basic events of the present invention. The events begin at a point in time after riders and vendors registered with the software application. The rider requests a pickup 30, to which the vendor responds 105. The consumer boards 104, with the software application capable of detecting that a consumer has boarded. One way that detection is performed is by recognizing the consumer via the vendor's device using consumer's digital signature. For example, during the signup steps 10 and 20, rider/consumer will be requested to read a sentence from the screen of his/her device, while the microphone of said device is activated in a recording mode. The peaks and troughs of rider's voice and manner of speaking will be detected and used later to identify this rider as his/her digital audio signature. Similarly, to verify that a sponsored message has been adequately broadcasted in, the software application 2 will maintain the vendor's microphone in an activated mode during transmissions, so that a broadcasted message may be heard and identified based on its digital audio signature. During the detection process the vendor and consumer may communicate, and their communication will be deemed as noise, thus not interfering with identification of a broadcasted message. The decibel level of conversations and other noise to signal ratio will be analyzed by the software application 2 to determine whether the broadcast of the sponsored message was translated at an adequate minimum compliance level, or level where a broadcasted message would be heard and understood. This may also be accomplished for example by determining that consumer's mobile device and vendor's mobile device, which have been used to summon transport and respond to transport, respectively, are in close proximity and/or traveling concomitantly. Once boarding is detected in step 106, the software uploads advertising content into vendor's device, in step 119. The content is immediately broadcasted 120 to the rider at the start of the trip 110, at certain intervals during the trip 110, or throughout the trip, depending on user preferences, certain safety factors, or availability of advertising content. The safety factors may include certain detection features that would interrupt the broadcast of advertising content, for example, to permit, the receipt or transmission of whether or safety alerts issued by authorized sources, or alerts from financial and social institutions alerting participants of dangers or problems.

At the end of the trip 110, the advertising activity is reported as to the consumer 132 and as to the vendor 134. In each case, the vendor is monitored to ensure that the message is broadcasted at acceptable decibel and static levels, and the rider is monitored more indirectly, to ensure that the consumer/rider is listening to the messages, or that the messages are sufficiently relevant to the rider to warrant his/her interest. If all activity is found at compliant levels then both the rider and vendor, or the party that was found to be compliant, are reimbursed from funds charged by the computer software to the advertising party (sponsor). Rider's reimbursement or subsidy is preferably in the form of a contribution made to the rate charged by vendors for the trip. Vendor's reimbursement or subsidy is preferably in the fog in of a reduction or elimination of a commission charged by the software application to the vendor. The application 2 may be configured to waive compliance rules partially or entirely and apply sponsor funded discount to all riders and vendors participating in the application 2.

The rider or even vendor is given an opportunity to provide a feedback 70. Which solicits a standard set of responses, such as quality of services and equipment provided by the vendor. The consumer may also opine as to the quality and relevance of the promotional content and the acceptability of the broadcast of said content through vendor's equipment. To further enforce attentiveness by rider and/or vendor, or advertisement relevance for rider, the software application 2 may quiz the vendor/rider (241 and 234) on personal preferences or on content of previously played promotional messages, to then analyze accuracy of responses.

FIG. 5 demonstrates that a vendor composes messages 180 with the help of the software application embodied in the present invention, and which comply with general formats unique to this application. For example, a message must be short and highly audible, to be clear heard above the din of travel. Once a message is composed, the advertiser participates in an auction 200 together with other advertisers which assigns a price to the advertiser's message. The message is then uploaded 232 to a device of a vendor(s), to be broadcasted 234 to rider(s). The broadcast of a message 234 would then be charged to the advertiser by the software application for every instance and minute during which it is played. This funding by the advertiser 230, combined with vendor's commissions, if any provide revenue to the software application's vendor to maintain and grow the vending method embodied by the present invention. For this reason, non-compliance by vendors or riders is monitored and enforced 240. For example, if a vendor is found to be inhibiting the broadcast 234 either deliberately, or by having faulty equipment, the vendor will be penalized by the software application vendor through fines, suspension or expulsion from the list of qualified vendors. Enforcement 240 is necessary to ensure that the guarantee of advertisement broadcasts by third parties is maintained.

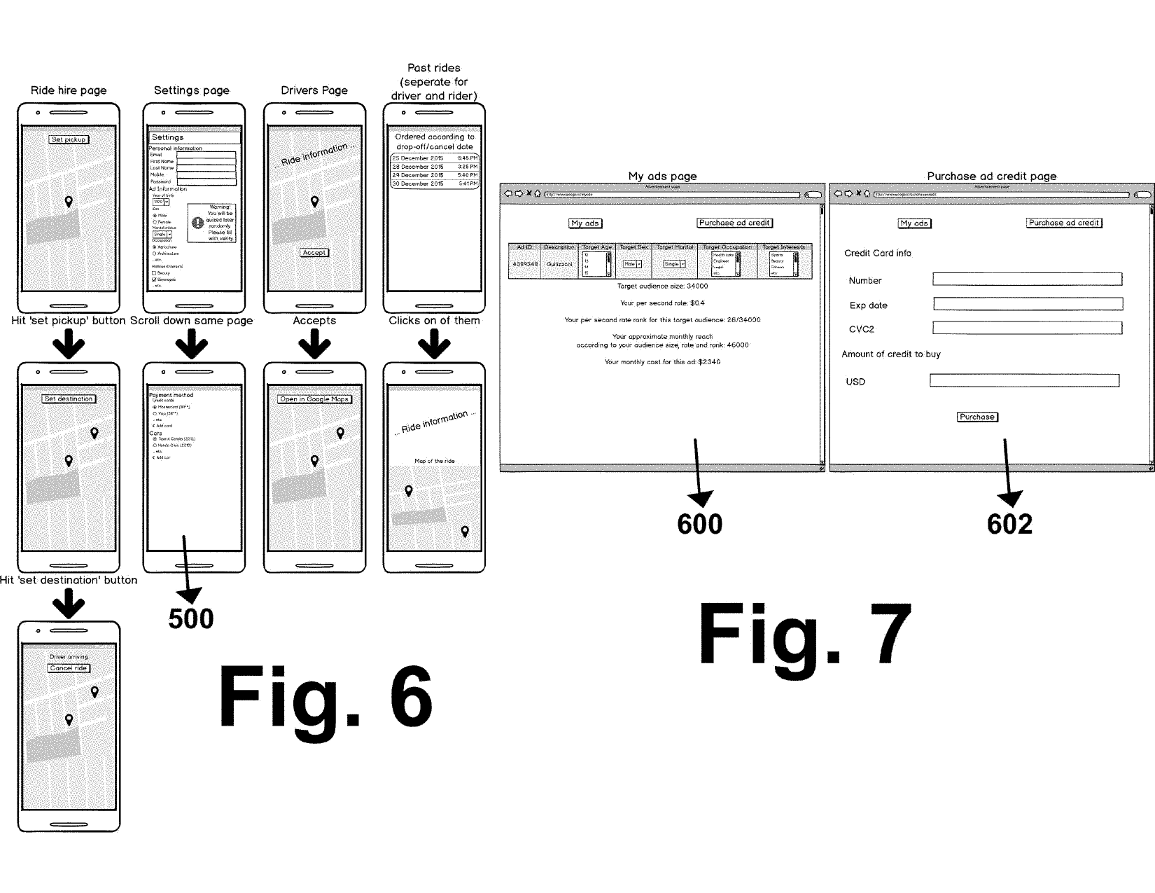

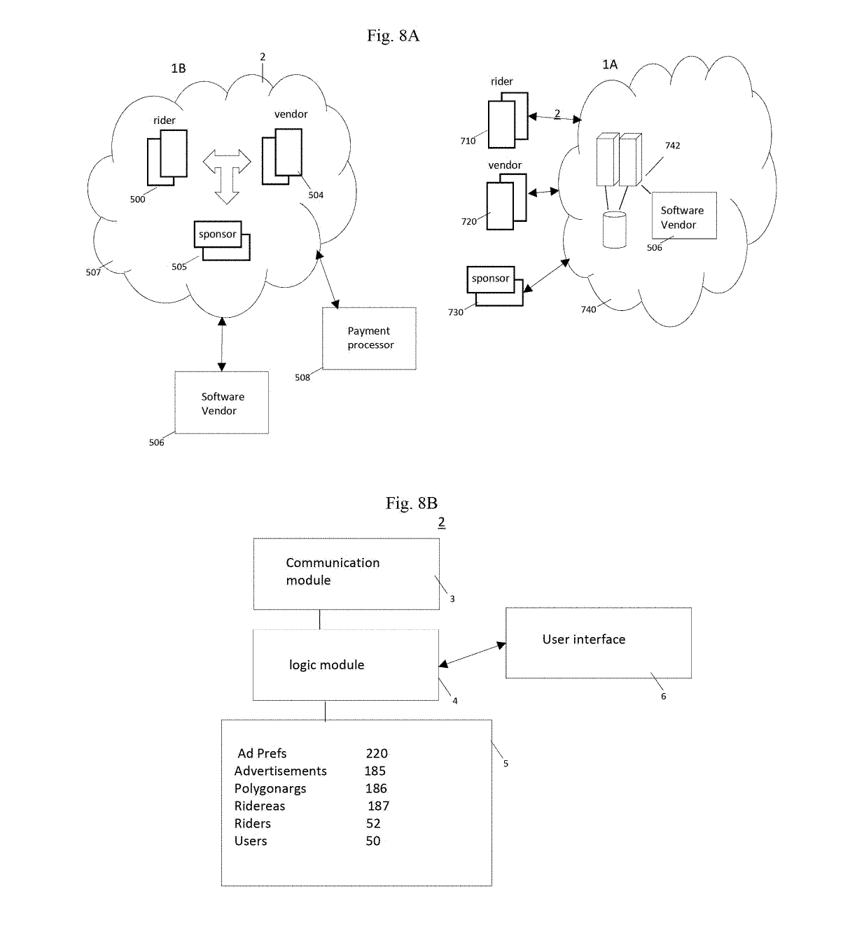

FIG. 6 demonstrates the user interface of the present invention. The interface is presented via the smart phone device 500 but may be displayed on a computer screen or any other visual display. The embodiment shown is in the context of a rider and driver of a private vehicle. In such context, a passenger summons a driver, who in this case is the vendor participating as a vendor in the software application, and a driver confirms the summons and travels to reach his/her passenger at a requested pickup location. Prior to user's confirmation of a pickup, the software package provides to the user the cost of the ride. Once the user confirms the cost, then the driver is dispatched. In the software package disclosed in the present invention, an additional screen may then inform the user and/or driver of the difference between the regular cost of this particular ride, or in case of a vendor, the regular earning from the job, and the cost of the ride or job earning upon full compliance with the advertisement broadcast requirement of the present invention. A similar interface exists for either the rider or the driver, except that the driver is also given a route if necessary.

FIG. 7 demonstrates additional screens provided by the software application embodied in the present invention. These screens are shown to the third-party sponsors. In screen 600 the sponsors create advertisement messages or identify parameters for such messages. In screen 602, the advertisers provide a payment means, identify start and end dates to the campaigns, specify the currency type and a maximum budget, that may be based on an hourly, daily, weekly or quarterly maximum, or limited to any other benchmark. Part of the means for verifying whether riders/consumers are paying attention to the advertising messages is by randomly quizzing the consumers regarding these messages. Questions for such quizzes may be compiled dynamically by the software application entered by the advertiser on a separate screen. The screenshots show may be implemented on a personal computer or full screen type computer device. However, a third-party advertiser screen may also be displayed using a smart phone device as shown in FIG. 6.

FIGS. 8A and 8B demonstrate the logical components of the software application 2. This description is one of the methods in enabling the application 2, and other methodologies may be known to those skilled in the art. The software application 2 may rim completely from a combination of mobile/remote devices as shown in 1B. In a mobile only embodiment 1B, the will be at least three mobile devices, one belonging to the rider 500, one to the vendor 502 and one to the sponsor 504. The three mobile/remote devices, which may be, but are not limited to, mobile phones, tablet computer devices, personal computers or remote servers, communicate with the software vendor 506. The software vendor 506 enables the software application 2, by recruiting additional riders 500, vendors 502 and sponsors 506. The internal application processes, such as broadcasting of advertisements, and reimbursement of fees, are carried out autonomously by the software application 2.

The software application 2 may utilize similar processes to process both the vendor and rider related processes. The software application 2 may be written in Objective-C, Java, JS, Swift and any other compatible language, whether or not utilizing a compatible or bridging framework. The application, on its own, or through a framework provided by the operating system, or by a third-party vendor such Phonegap® or Monotouch®, will make hardware calls to activate or deactivate hardware components and receive data therefrom or transmit thereto. For example, during the signup process for either the rider, vendor or sponsor, the communication module will present a user interface to collect data. Said data will be written into a database, which may be sqllite® or as simple as a searchable list. To be even more granular, a rider would enter his/her personal information, such, as payment method, name and telephone number. The rider may then read a statement out loud so that rider's voice may be recorded to be used later for identification purposes or to detect boarding of a vendor's transportation medium, with transportation medium being car, bus, train or airplane. The logic module combines such data from rider into the riders database 52 and personal data into users database 50. Records between said databases will be ordered by personal information or digital signature of said user/rider. In 1A where there is no central server, information between individual instances of application 2 will be shared between individual devices, for example, at the time of request of services. To further elucidate, when the rider 500 requests services from the software app 2, the software application will check proximity of any vendor nearby. The list of vendors may also be continuously uploaded from Software Vendor 506. During the request, the software app 2 on rider's device 500 will activate the transmitter hardware of the device, most commonly a radio transmitter, a photon transmitter, or electrical impulse transmitter, which would connect to an external network 507. The software app 2 will then transmit relevant rider's information from rider's device 500 to vendor's device 504. The software app 2 on vendor's device would have by then enabled a communication module 3, which in turn would enable a hardware receiver of the vendor's device 504, which may be a radio receiver or a network card. The logic module 4 would then interpret the information from the rider's device and store it in runtime memory of the vendor's device 504, or recorded in a ridereas database 187 or riders database 57 on the vendor's device 504. The logic module 4 of the vendor's device 504 would then respond to the rider's device 500 with relevant information, such as the required fare, estimated pickup time and arrival time, which may be calculated using the polygonargs database 186 in conjunction with riders database 52 and ridereas 187.

Sponsor's participation would work in a similar fashion. The sponsor device 505 would have a user interface 6 and would enter information into logic module 4. Among the setup steps, a sponsor would also compose an advertisement to be broadcasted to consumers/riders. The advertisement would be stored in advertisements database 185. Thus, when rider 500 requests services from vendor 504, the vendor device 504, through communication module 3 on vendor and sponsor devices 505 requests for a transmission of the advertisement. The sponsor device 505 may be located by proximity or as provided from the list maintained by the software vendor 506, which would be loadable through communication module 3 that is connected to a network 507. The vendor 504 would than broadcast the advertisement and upload broadcasting information, such as decibel level and broadcasting signature, etc., back to the communication module of the sponsor device 505 to be compared and judged by logic module 4 of the sponsor device 505 against an acceptable standard stated in the advertisements database 185. Based on compliance level, or a preset waiver of compliance requirements, the payment processor would then pay the software vendor 506 from funds of rider 500 and sponsor 505 and direct a payment to vendor 504. Alternatively, the software app 2 would dictate the amount to be charged to the rider 500 and sponsor 505 and forwarded to software vendor 506 and vendor 504 whether or not subject to any compliance preconditions.

The method 1A of FIG. 8A demonstrates, the same software processes as in 113 except that the exchange of information between rider device 710, vendor device 720 and sponsor device 730 is done via a central server 742 that is running a full version of the software application 2, and monitored or maintained by the software vendor 506. The individual devices 710, 720 and 730 would run their instances of software application 2 and upload and download information to and from the server 742 related to their role in the software application 2, namely whether they were rider, vendor or sponsor. Since the application 2 is the same for either rider vendor or sponsor, with only various storage techniques and data processing changing, a vendor 720 may also be a rider 710 or a sponsor 730. Or a sponsor 730 may be a rider 710 or a vendor 720 by merely changing to purpose of the login and by submitting a request/registration to the software vendor 506

A more centralized solution 1A includes the same components except that the software application 2 is spread across the devices belonging to the rider(s) 710, the vendor(s) 720 the sponsor(s) 730 and the server infrastructure 740 that is supported by the software vendor 506. The application processes in 1A are similar to 1B, except that in IA the software vendor may manage and calibrate bandwidth in addition to promoting the software application 2.

The basic components of the application 2 remain the same. There is a communication module 2, the logic module 4, the storage module 5 and the user interface 6. The same three components exist whether the software application instance is running on a rider's device, a vendor's device, or the sponsor's device. The storage module 5 may be further broken down to containing various interconnected databases, or tablespaces within the same database. These databases may include, but are not limited to adprefs 220, which stores the customer preferences of advertisement messages; the advertisements database 185 that contains the actual promotional messages; polygonarrays database 186, which tracks the coordinates of all users of the software application 2, and calculates pricing between various points; the ridereqs database 187, to calculate surge pricing and other special fees; the rides database 52 storing prior activity history for both consumers and vendors, and which may also store compliance levels with rules pertaining to support messages; and users database 50 which records information for riders, vendors and sponsors.

The communication module 3 is responsible for receiving new and existing user logins, transportation service requests and responses. sponsor messages uploads from database to vendor's equipment, and internal software communication. The logic module 5 is responsible for calculating user participation, user pricing, flow of charges between various users of this invention, upload and management of advertising materials and compliance by riders and vendors with broadcasting parameters of the application 2. Broadcasting parameters are set by the sponsor 730 during signup and setup of specific advertisement. There are certain innate parameters that are always enforced, such as the parameter that requires broadcast by the software application 2. The software application component executing on the, vendor's device (502 or 720) connects to the noise/voice detection capability of vendor's equipment during the broadcasting of the advertisement to ensure that the broadcast is sufficiently loud and that there are no other interfering noises. The software application will also engage the spatial assessment capabilities of the vendor/rider's device, to verify whether the messages are plying at the time when riders are present inside the vendor's transportation medium, and to ensure that they is sufficient proximity between riders and vendors to ensure that the message is heard.

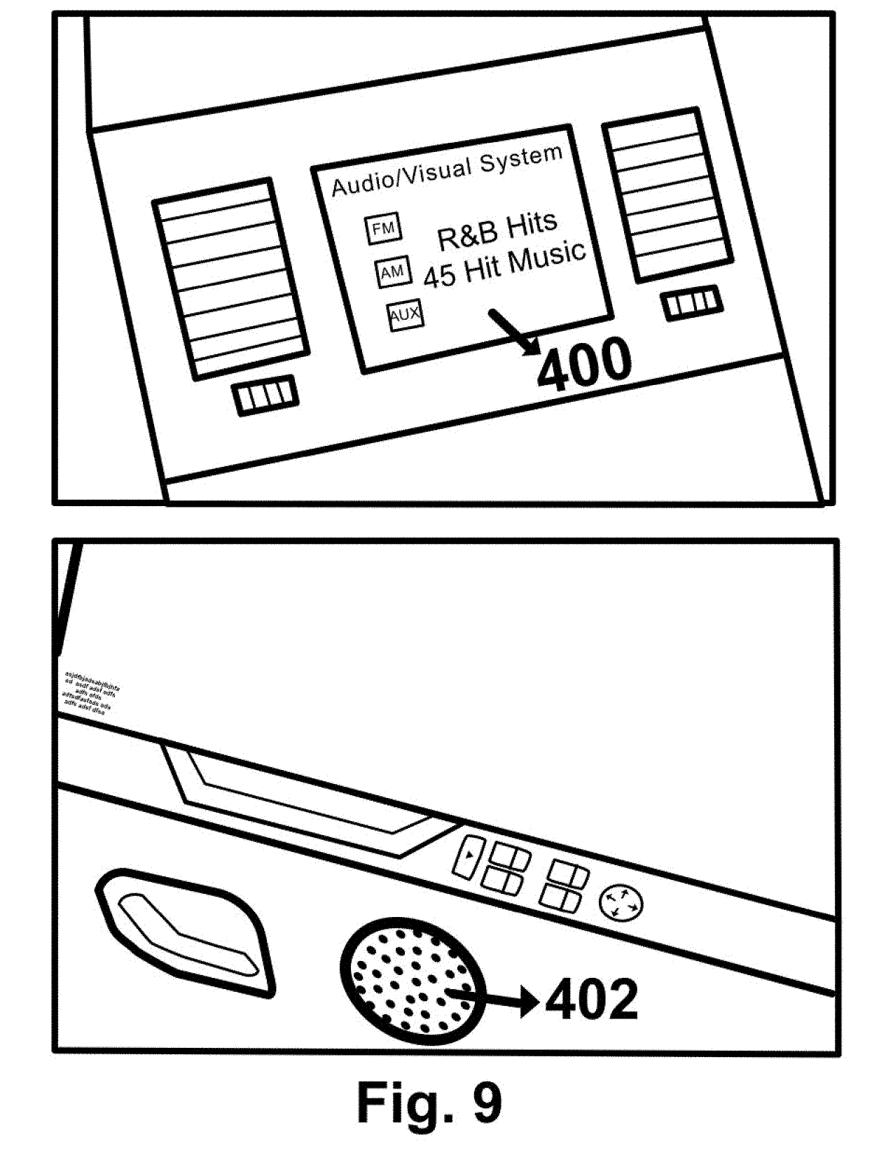

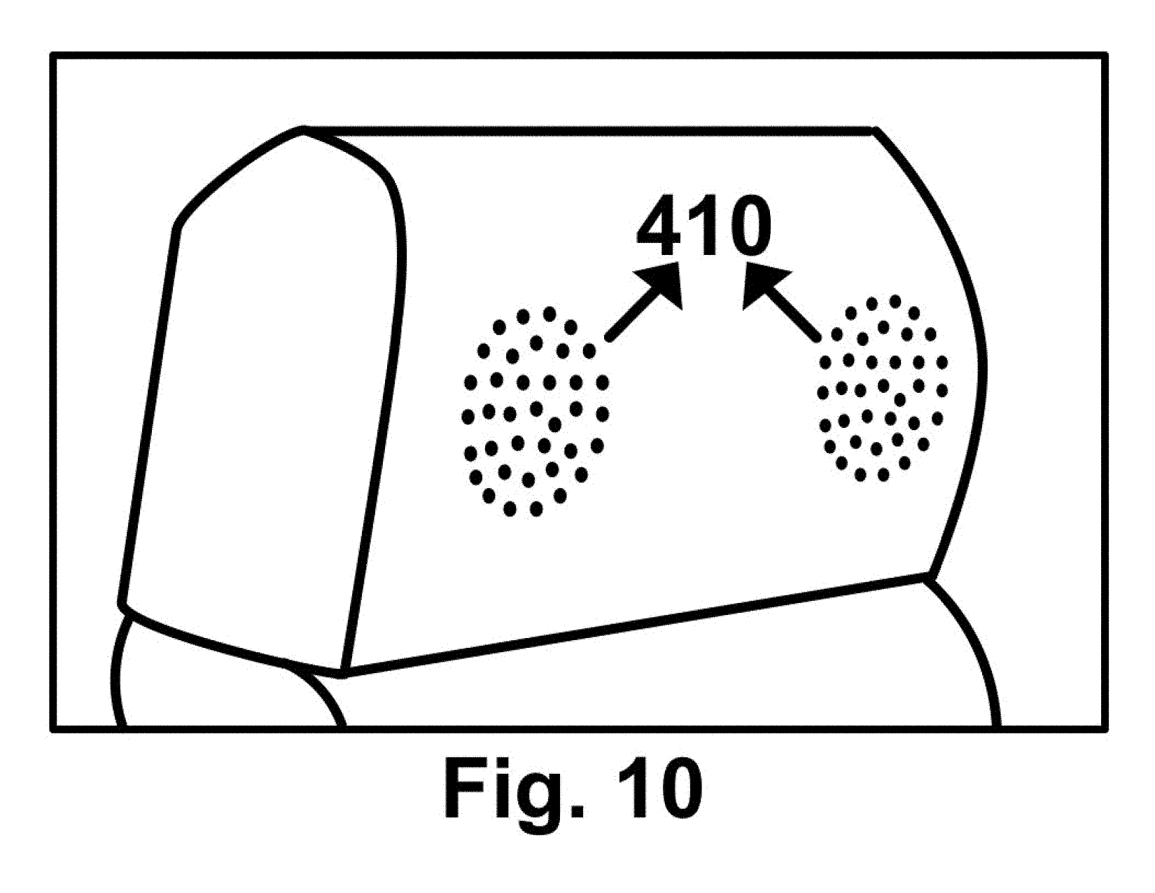

FIGS. 9 and 10 demonstrate some of the settings for usage of the present invention. Once the rider enters the vendors transportation vehicle, which may be, but is not limited to an automobile, a limousine, a bus, train, plain or an unmanned vehicle of some kind, the software application 2 will ensure that vendor's equipment is connected, via short radio waives or otherwise, to the audio/video system of the vehicle. If such connection is present, the messages are played through the vehicle audio/visual system 400, which plays the messages directly to vehicle's speakers 402. In cases where multiple passengers are present, for example in a ride sharing setting, or if the vehicle is a bus, train or airplane, having multiple passengers, the messages will be transmitted to each passenger/rider based on the rider's individual preferences, to the audio (or visual if applicable) equipment that is in close proximity with that rider, as shown as item 410 in FIG. 10. Alternatively, the software application 2 will broadcast one message to all consumers/riders based on a common selection of all riders present.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed:

1. A transportation reservation system comprising: a software application, said software application having a communication module, a logic module and a database module; said software application deployed across at least one computer device of a rider, at least one computer device of a vendor and at least one computer device of a sponsor; wherein said rider capable of engaging said soft are application to request a transportation service from a vendor; wherein said sponsor loading a set of promotional messages into said software application, said promotional messages to be broadcasted to said rider by said vendor; wherein said rider paying a fare to said vendor for transportation service through said software application, and wherein said vendor paying a vendor of said software application a commission that is a percentage of said fare; and wherein said sponsor sharing a percentage of said fair with said rider and a percentage of said commission of said vendor to said vendor of said software application in exchange for broadcasting of promotional messages of said sponsor to said rider.

2. The transportation reservation system of claim 1, wherein said software application further comprising detection of level of broadcast of said promotional message to said rider.

3. The transportation reservation system of claim 2, wherein said software application setting a broadcast level compliance, wherein said sharing of said fare or said sharing of said commission by said sponsor is at a rate that is directly proportional to the broadcast level compliance by said vendor or said rider.

4. The transportation reservation system of claim 1, wherein said software application broadcasts said promotional messages to said rider using said vendor's equipment, wherein said vendor's device is connected to said vendor's equipment using a wired or wireless connection.

5. The transportation reservation system of claim 1, wherein said database module is disposed on a central server.

6. The transportation reservation system of claim 1, wherein said database module is disposed across said at least one rider device and said at least one vendor device.

7. The transportation reservation system of claim 6, wherein said logic module, said communication module and said database module are disposed across said at least one rider device said at least one vendor device and said at least one sponsor device.

8. The transportation reservation system of claim 1, wherein said promotional message is broadcasted separately to each individual rider occupying transportation equipment of said at east one vendor.

9. The transportation reservation system of claim 1, wherein said promotional message is broadcasted to all riders together based on a common interest shared by all said riders.

10. The transportation reservation system of claim 1, wherein said software application of said rider uploads a data describing said rider to another instance of said software application, said another instance deployed on a device of said at least one vendor at the time when said at least one vendor's services are requested.

11. The transportation reservation system of claim 1, wherein said software application of said at least one vendor or said at sponsor uploads messages to an instance of said software application deployed on a device of said at least one rider when said at least one rider requests services from said at least one vendor or when said at least one rider boards a transportation medium of said one vendor.

12. A method of reserving subsidized transportation requests comprising the steps of utilizing a software application to register at least one rider, registering at least one vendor and registering at least one sponsor; said at least one sponsor creating at least one promotional message within said software application; said at least one sponsor configuring broad cast parameters for replaying of said promotional messages; said at least one rider requesting a transportation service from said at least one vendor; said at least one vendor providing said transportation service to said at least one rider; broadcasting of said at least one promotional message to said rider during the provision of said transportation service by said vendor; and charging a payment to, said at least one sponsor for broadcasting said at least one promotional message.

13. The method of reserving subsidized transportation of claim 12, further comprising the steps of said software application applying a portion of said payment by said at least one sponsor for a portion of a fare paid by said at least one rider to said at least one vendor; and said software application applying a portion of said payment by said at least one sponsor for a portion of a commission paid by said at least one vendor to a vendor of said software application.

14. The method of reserving subsidized transportation of claim 13, further comprising the steps of setting a minimum broadcasting compliance level; detection by said software application whether said broadcasting compliance level has been met.

15. The method of reserving subsidized transportation of claim 14, further comprising the step of enforcing compliance with said minimum broadcasting compliance level by diminishing said portion of said fare or said commission paid by said sponsor.
